(19) United States
(12) Patent Application Publication
(10) Pub. No.: US 2015/0379457 A1
(43) Pub. Date: Dec. 31, 2015

(54) Method and Apparatus for Task Driven Operations for Construction Machines

(71) Applicant: Topcon Positioning Systems, Inc., Livermore, CA (US)

(72) Inventor: Richard Jackson, Redland Bay (AU)

(73) Assignee: TOPCON POSITIONING SYSTEMS, INC., Livermore, CA (US)

(21) Appl. No.: 14/747,304

(22) Filed: Jun. 23, 2015

Related U.S. Application Data
(60) Provisional application No. 62/017,929, filed on Jun. 27, 2014.

(51) Int. Cl. G06Q 10/06; G06Q 50/08

(52) U.S. Cl. CPC G06Q 10/063118; G06Q 50/08

(57) ABSTRACT

A system and method for scheduling tasks of a construction project includes dividing a plan for a construction project into a plurality of tasks. Each particular task of the plurality of tasks is defined by one or more parameters. The one or more parameters of each particular task are modified based on an operational model defining a sequence of actions for performing the particular task. A construction machine is assigned to each particular task based on the modified one or more parameters of the particular task. Each particular task is dispatched to the construction machine assigned to the particular task for presenting the sequence of actions for performing the particular task.

This application claims the benefit of U.S. Provisional Application No. 62/017,929, filed Jun. 27, 2014, the disclosure of which is herein incorporated by reference in its entirety.

### BACKGROUND OF THE INVENTION

The present invention relates generally to construction project management and more particularly to task-driven management of a construction project.

Construction sites are currently managed by a job supervisor. Conventionally, the job supervisor manually breaks down a construction project into tasks assigned to an operator of construction equipment or machine. The tasks are typically dispatched to the operator of the construction machine as electronic files stored on a data storage device, such as a universal serial bus (USB) flash drive. The operator physically delivers the data storage device storing the electronic files of the task to his or her construction machine, where the task can be accessed electronically. However, this results in inconvenience and inefficiency in defining the tasks and dispatching the tasks to the construction machines.

### BRIEF SUMMARY OF THE INVENTION

A system and method for scheduling tasks of a construction project includes dividing a plan for a construction project into a plurality of tasks. Each particular task of the plurality of tasks is defined by one or more parameters. The one or more parameters of each particular task are modified based on an operational model defining a sequence of actions for performing the particular task. A construction machine is assigned to each particular task based on the modified one or more parameters of the particular task. Each particular task is dispatched to the construction machine assigned to the particular task for presenting the sequence of actions for performing the particular task.

These and other advantages of the invention will be apparent to those of ordinary skill in the art by reference to the following detailed description and the accompanying drawings.

### BRIEF DESCRIPTION OF THE DRAWINGS

FIG. 1 depicts an exemplary excavator, in accordance with one or more embodiments;

FIG. 2 depicts a high-level overview of a construction site, in accordance with one or more embodiments;

FIG. 3 depicts a supervision system for scheduling tasks of a construction project, in accordance with one or more embodiments;

FIG. 4 depicts a flow diagram of a method for scheduling tasks of a construction project, in accordance with one or more embodiments; and

FIG. 5 depicts a high-level schematic of a computer system, in accordance with one or more embodiments.

### DETAILED DESCRIPTION

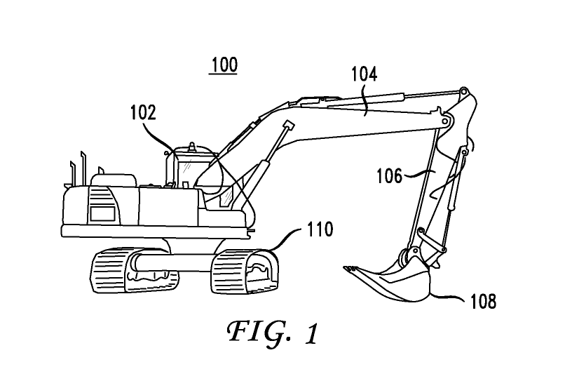

FIG. 1 shows an exemplary construction equipment or machine in accordance with one or more embodiments. The machine in FIG. 1 is shown as an excavator 100. Excavator 100 includes cab 102, boom 104, stick 106, and bucket 108. Cab 102, boom 104, stick 106, and bucket 108 are rotatably mounted on an undercarriage 110 of excavator 100, which may include tracks or wheels. An operator controls excavator 100 from cab 102 to move it to a desired location and manipulate various materials, such as dirt.

A construction project may involve multiple machines (e.g., excavator 100). Any incorrect or unscheduled action of the machines by the operator, for example, due to stress or limited capability, directly impacts the health of the machine, the safety of the operator and other workers, the productivity of the operator, and the cost of the operations. Examples of incorrect actions on excavator 100 include stressing boom 104, roughly swinging stick 106, and under filling bucket 108. In order to reduce the number of incorrect or unscheduled actions, tasks are assigned to operators of each machine to provide guidance, feedback and other pertinent information.

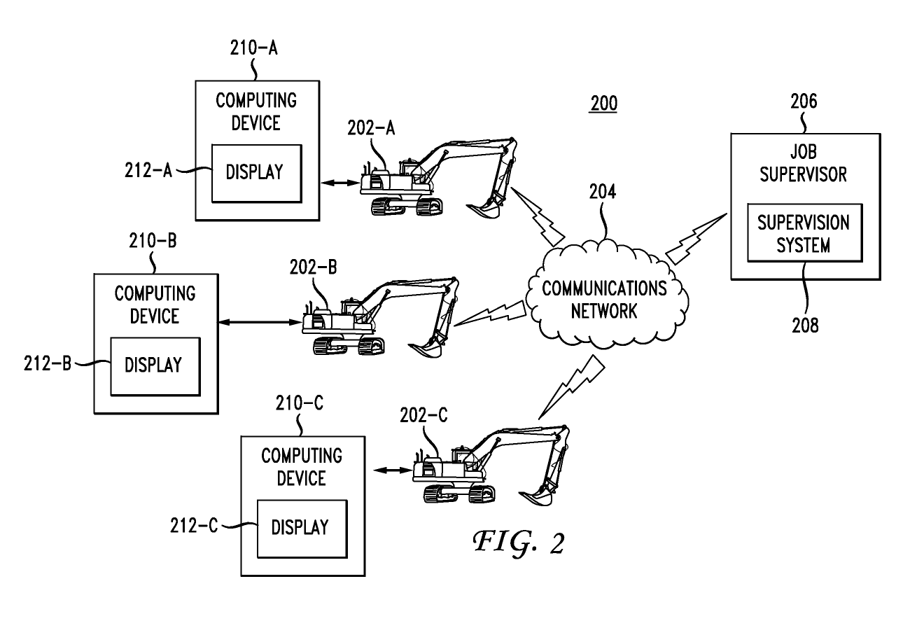

FIG. 2 shows a high-level overview of a construction site 200 in accordance with one or more embodiments. Construction site 200 includes machines or devices 202-A, 202-B, and 202-C, collectively referred to as machines 202. Machines 202 may include any machine or device for construction, such as, e.g., a bulldozer, dump truck, crane, excavator, or any other type of equipment. In one embodiment, machines 202 include excavator 100 shown in FIG. 1. It should be understood that while machines 202 are shown in FIG. 2 as machines 202-A, 202-B, and 202-C, machines 202 may include any number of machines of a same or different type.

Communications network 204 facilitates communication between two or more machines 202 (or operators of machines 202) and/or job supervisor 206. Machines 202 (or operators of machines 202) communicate via computing devices 210-A, 210-B, and 210-C, respectively, collectively referred to a computing devices 210. Communications network 204 may include any suitable network, such as, e.g., a wired or wireless computer network, the Internet, a telephone network, a cellular network, a satellite network, etc. In one embodiment, communications network 204 is a mesh network where each machine 202 (via computing device 210) and job supervisor 206 acts as a node to cooperate in the distribution of data. In this embodiment, each node is communicatively coupled with all other nodes (that are within communication range).

Operators may communicate over communications network 204 using computing devices 210. Computing devices 210 may include any device capable of communicating over communications network 204, such as, e.g., a mobile phone, a tablet, a computer, smart glasses, etc. Computing devices 210 may include displays 212-A, 212-B, and 212-C, respectively, collectively referred to as displays 212. Displays 212 may display the tasks and other pertinent information. In one embodiment, computing devices 210 are external systems independent of their associated machines 202. For example, computing devices 210 may be mobile computing devices of operators of machines 202. This embodiment may be particularly useful where job supervisor 206 dispatches a simple task to the operator. In another embodiment, computing devices 210 are internal modules of their associated machines 202, which may be advantageous for complex sets of tasks.

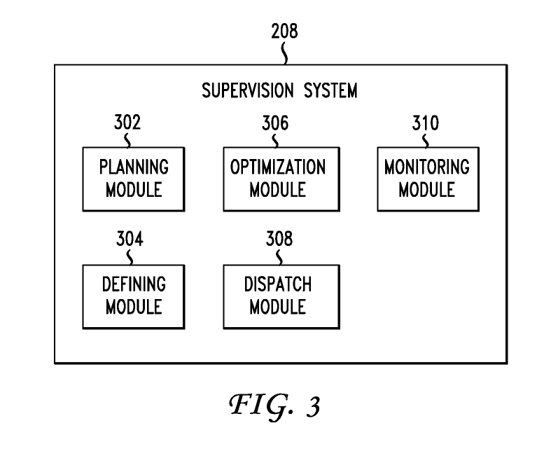

Job supervisor 206 oversees the planning and operations of the entire construction project of construction site 200 from a site office. Job supervisor 206 includes or otherwise interacts with supervision system 208 for overseeing operations of construction site 200. Supervision system 208 is described in further detail with respect to FIG. 3.

FIG. 3 shows an exemplary supervision system 208 in accordance with one or more embodiments. Job supervisor 206 (or any other use) interacts with supervision system 208 for overseeing operations of the construction project at construction site 200. Supervision system 208 includes planning module 302, defining module 304, optimization module 306, dispatch module 308, and monitoring module 310.

Supervision system 208 includes planning module 302 for planning and scheduling tasks. Planning module 302 receives a project file indicating a plan for the construction project. The project file includes, e.g., three-dimensional surface models, bill of materials for the whole site or a portion of the site, machine resource availability, and any other relevant information. Planning module 302 breaks down or divides the project file into a sequence of tasks to be performed to complete the construction project. In one embodiment, the job supervisor 206 (or another user) interacts with planning module 302 to manually break down the construction project into tasks. The job supervisor 206 then plans and schedules the tasks through planning module 302. In other embodiments, planning module 302 automatically converts the construction project into tasks and schedules the tasks. The granularity of the task depends on many different factors, including, e.g., machine resource availability, physical region constraints, material type, etc.

Defining module 304 receives input from job supervisor 206 to define parameters of each task identified by planning module 302. Parameters of a task may include, e.g., a geographic region selected for a task (e.g., a polygonal area), a target surface, alignments and grade offsets, a material type (e.g., dirt), a material destination (e.g., landfill, waste, export), team members or operators involved (i.e., machine allocation), volume expectations (based on, e.g., the 3 dimensional target and existing ground topography), and schedule expectations (e.g., based on machine capacities, work calendar, environmentals). Other parameters may also be employed.

Optimization module 306 optimizes the scheduling of tasks based on the parameters defined for each task. In particular, optimization module 306 applies optimal operational models to the tasks to provide for optimal locations and sequences of actions to operators of machines 202. In one embodiment, optimization module 306 optimizes task scheduling by automatically selecting an optimal operational model based on the task type. In other embodiments, optimization module 306 permits user selection of an optimal operational model by job supervisor 206. Alternatively, job supervisor 206 can interact with optimization module 306 to define custom operational models tailored to that specific construction project. In one example, optimization module 306 optimizes the excavation task and the haul task to synchronize the timing of the tasks. In another example, optimization module 306 optimizes the material cut task and the fill task. The optimization (i.e., the operational model) is embedded into the definition of the tasks to present the optimal locations and sequences of actions to the machine operators.

In an illustrative embodiment, the task of spreading material (e.g., top soil) over an area may involve one or more bulldozers working in unison. An optimization model may dictate the best operational trajectories of each machine based on material volume, dumping location, existing and final surface models, machine capabilities, etc.

Dispatch module 308 dispatches tasks to machines 202 (or operators of machines 202) electronically (e.g., wirelessly) over communications network 204 via computing devices 210. Tasks can be dispatched for a given period of time, such as, e.g., tasks for a day, tasks for a week, tasks for the entire project, etc., which can be determined by job supervisor 206 or the operator. Tasks can also be dispatched one at a time upon completion of a prior task. Tasks are dispatched to computing devices 210 associated with machines 202 (or operators of machines 202) and presented to the operator to facilitate the efficient and safe completion of the tasks. Presentation of the tasks may involve one or more display elements, such as, e.g., displays 212. Tasks may be presented to an operator graphically (e.g., a colored overlay on a map) or textually (e.g., a list with descriptive information) using the display elements.

Monitoring module 310 permits operators, job supervisor 206, or other users to monitor the performance of operators of machines 202. The performance may be measured based on one or more performance metrics. In one embodiment, the performance metrics may be predefined for a particular task. In other embodiments, a user may interact with monitoring module 310 to input a custom performance metric. For example, the performance metric for the task of excavation and bulk earthworks may include cubic yards (or meters) per hour and the performance metric for the task of compaction and fine-grading applications may include square feet (or meters) per hour. The performance metrics can be offset by the need for optimizing machine usage for the sake of longevity or other factors.

The performance of the operator can be compared against previous performances of the operator, performances of operators of similar tasks, a goal set by job supervisor 206, etc. In one embodiment, an operator can monitor his or her productivity against a database of optimal machine and team practices. In this embodiment, operators (particularly inexperienced operators) can be guided by these optimal practices. Monitoring module 310 can also be used to measure an amount of completion and/or an estimated time to completion. This will provide the operator and job supervisor 206 with information indicating whether the task will be completed as scheduled.

The performance of the operator may be visualized at the site office of the job supervisor, at machine 202 (using computing devices 210), or at any other location. This may involve one or more display elements (e.g., displays 212) to provide visual feedback in real-time or near real-time to the operator (or job supervisor 206 or other users) while executing the task to inform the operator of what is not optimal and how the he or she can improve. In one embodiment, the display elements are augmented reality display devices for augmenting a live direct view of the physical world with information relating to the task, the construction project, and/or other information. For example, windows of cab 102 of excavator 100 of FIG. 1 can be configured as the augmented reality display to provide an augmented reality view to the operator. Other examples of augmented reality display devices include a head-mounted display such as a visor of a protective helmet, smart glasses, contact lenses, etc.

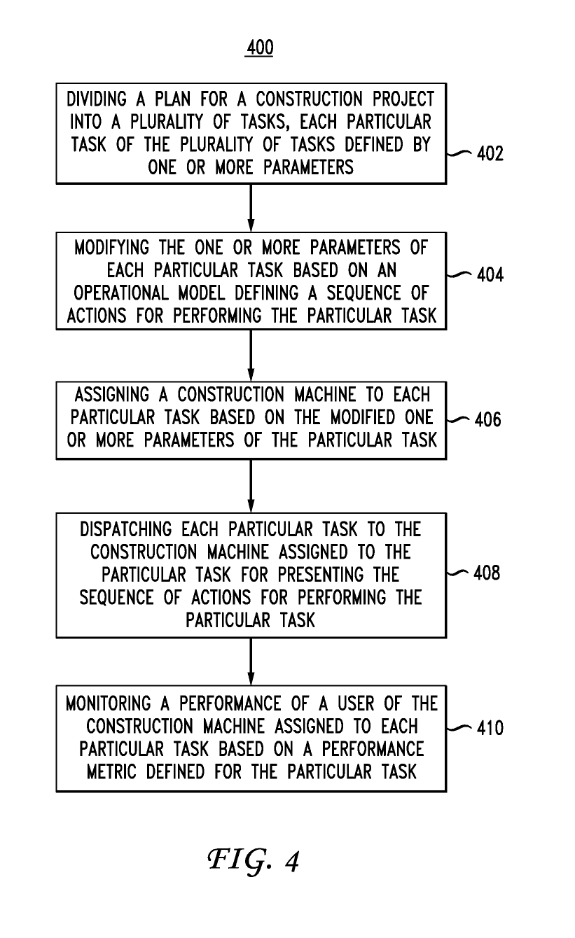

FIG. 4 shows an exemplary method 400 for scheduling tasks of a construction project, in accordance with one or more embodiments. Method 400 may be performed by, e.g., supervision system 208.

At step 402, a plan for a construction project is divided into a plurality of tasks. The plan for the construction project may be represented as an electronic file including three-dimensional surface models of a geographic region for the respective task, bill of materials for the construction site, machine resource availability, etc. The plan for the construction project may be divided into the plurality of tasks automatically. In one embodiment, a construction project can be automatically divided into a plurality of tasks based on the type of the construction project. For example, the construction project of building a road may include inherent layering and geometrical constraints that can be used to automate region definition. Machine types and capacities can also be automatically determined based on task and material type, e.g., base-course spreading, paving and compaction, etc. Additionally or alternatively, the plan for the construction project may be divided manually (e.g., by receiving input from a job supervisor). The granularity of the tasks may be based on, e.g., machine resource availability, physical region constraints, material type, etc.

Each particular task of the plurality of tasks are defined by one or more parameters. In one embodiment, the parameters may be received as user input from, e.g., the job supervisor, machine operator, or any other user. The parameters may include, for example, a geographic region selected for a task, a target surface, alignments and grade offsets, a material type, a material destination, users or operators involved, volume expectations, or any other parameter.

At step 404, the one or more parameters of each particular task are modified based on an operational model. The operational model defines a sequence of actions and locations of construction machines for performing the particular task. The operational model may be automatically selected based on the type of a particular task or may be selected by user input from, e.g., a job supervisor. For example, the operational model may optimize timing and operational trajectories of a plurality of construction machines for performing the particular task. The operational models are embedded into the definition of each particular task by modifying the one or more parameters of the particular task.

In one exemplary embodiment, the operational model includes individual trajectory and pass-count planning for a group of compacting rollers working collectively on an asphalt compaction task. Trajectories and pass-counts are prescriptive sequences of machine movements that can be determined manually or automatically (e.g., using path-planning software). In general, such operational models can be determined prior to task execution. However, it may also be necessary to modify operational models dynamically due to changing circumstances on site during task execution, e.g., using communications network 204.

At step 406, a construction machine is assigned to each particular task based on the modified one or more parameters of the particular task. At step 408, each particular task is dispatched or sent to the construction machine assigned to the particular task for presenting the sequence of actions for performing the particular task. Each particular task may be sent over a network, such as, e.g., a mesh network or a cellular network. The tasks may be sent for a particular time period, such as, e.g., a single task, tasks for a day, tasks for a week, tasks for the construction project, etc.

Each particular task is presented to a user (e.g., operator) of the at least one construction machine for performing the particular task.

At step 410, a performance of a user of the construction machine assigned to each particular task is monitored based on a performance metric defined for the particular task. The performance of the user is monitored using data received from the construction machine. The data may include measurements or statistics of metrics indicating productivity of the user of the construction machine for the particular task, e.g., based on sensors of the at least one construction machine. The metric may be a predetermined metric for a particular task. For example, for the task of excavating dirt, the metric may include the amount of dirt excavated. The performance of the user of the construction machine may be evaluated by comparing the data to, e.g., historical performances of the user, performances of other operators performing a same or similar task, a goal set by a job supervisor, etc. In one embodiment, data may be sent to the user of the at least one construction machine for displaying feedback to the user.

Systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIG. 4. Certain steps of the methods described herein, including one or more of the steps of FIG. 4, may be performed by a server or by another processor in a network-based cloud-computing system. Certain steps of the methods described herein, including one or more of the steps of FIG. 4, may be performed by a client computer in a network-based cloud computing system. The steps of the methods described herein, including one or more of the steps of FIG. 4, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 4, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

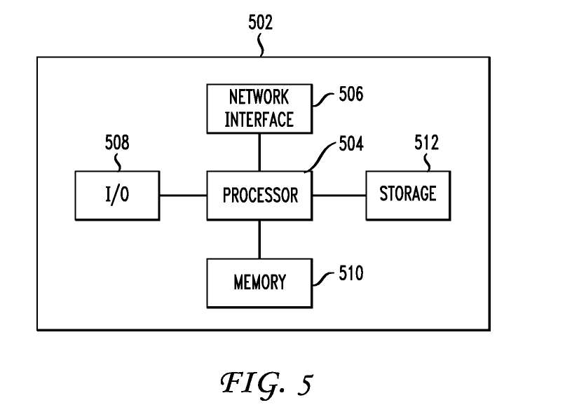

A high-level block diagram 500 of an example computer that may be used to implement systems, apparatus, and methods described herein is depicted in FIG. 5. Computer 502 includes a processor 504 operatively coupled to a data storage device 512 and a memory 510. Processor 504 controls the overall operation of computer 502 by executing computer program instructions that define such operations. The computer program instructions may be stored in data storage device 512, or other computer readable medium, and loaded into memory 510 when execution of the computer program instructions is desired. Thus, the method steps of FIG. 4 can be defined by the computer program instructions stored in memory 510 and/or data storage device 512 and controlled by processor 504 executing the computer program instructions. For example, the computer program instructions can be implemented as computer executable code programmed by one skilled in the art to perform the method steps of FIG. 4. Accordingly, by executing the computer program instructions, the processor 504 executes the method steps of FIG. 4. Computer 502 may also include one or more network interfaces 506 for communicating with other devices via a network. Computer 502 may also include one or more input/output devices 508 that enable user interaction with computer 502 (e.g., display, keyboard, mouse, speakers, buttons, etc.).

Processor 504 may include both general and special purpose microprocessors, and may be the sole processor or one of multiple processors of computer 502. Processor 504 may include one or more central processing units (CPUs), for example. Processor 504, data storage device 512, and/or memory 510 may include, be supplemented by, or incorporated in, one or more application-specific integrated circuits (ASICs) and/or one or more field programmable gate arrays (FPGAs).

Data storage device 512 and memory 510 each include a tangible non-transitory computer readable storage medium. Data storage device 512, and memory 510, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 508 may include peripherals, such as a printer, scanner, display screen, etc. For example, input/output devices 508 may include a display device such as a cathode ray tube (CRT) or liquid crystal display (LCD) monitor for displaying information to the user, a keyboard, and a pointing device such as a mouse or a trackball by which the user can provide input to computer 502.

Any or all of the systems and apparatus discussed herein, including supervision system 208 of FIG. 3, may be implemented using one or more computers such as computer 502.

One skilled in the art will recognize that an implementation of an actual computer or computer system may have other structures and may contain other components as well, and that FIG. 5 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for scheduling tasks of a construction project, comprising:
dividing a plan for a construction project into a plurality of tasks, each particular task of the plurality of tasks defined by one or more parameters;
modifying the one or more parameters of each particular task based on an operational model defining a sequence of actions for performing the particular task;
assigning a construction machine to each particular task based on the modified one or more parameters of the particular task; and
dispatching each particular task to the construction machine assigned to the particular task for presenting the sequence of actions for performing the particular task.

2. The method as recited in claim 1, further comprising:
monitoring a performance of a user of the construction machine assigned to each particular task based on a performance metric defined for the particular task.

3. The method as recited in claim 2, further comprising:
sending feedback data to the construction machine assigned to each particular task based on the performance of the user.

4. The method as recited in claim 1, wherein modifying the one or more parameters of each particular task based on an operational model defining a sequence of actions for performing the particular task comprises:
selecting the operational model defining the sequence of actions for performing the particular task based on a type of the particular task.

5. The method as recited in claim 1, wherein modifying the one or more parameters of each particular task based on an operational model defining a sequence of actions for performing the particular task comprises:
modifying the one or more parameters of each particular task based on the operational model defining a location of the construction machine assigned to the particular task for performing the particular task.

6. The method as recited in claim 1, wherein modifying the one or more parameters of each particular task based on an operational model defining a sequence of actions for performing the particular task comprises:
synchronizing a timing and operational trajectories of a plurality of construction machines for performing the particular task.

7. The method as recited in claim 1, wherein dividing a plan for a construction project into a plurality of tasks comprises:
dividing the plan for the construction project into the plurality of tasks having a granularity determined based on at least one of machine resource availability, geographic region constraints, and material type.

8. The method as recited in claim 1, wherein the one or more parameters of each particular task comprise at least one of a geographic region, a target surface, a material type, and a material destination.

9. The method as recited in claim 1, wherein the plan for the construction project includes at least one of a surface model for a geographic region of the construction project, a bill of materials for the construction project, and machine resource availability.

10. An apparatus for scheduling tasks of a construction project, comprising:
a processor; and
a memory to store computer program instructions, the computer program instructions when executed on the processor cause the processor to perform operations comprising:
dividing a plan for a construction project into a plurality of tasks, each particular task of the plurality of tasks defined by one or more parameters;
modifying the one or more parameters of each particular task based on an operational model defining a sequence of actions for performing the particular task;
assigning a construction machine to each particular task based on the modified one or more parameters of the particular task; and
dispatching each particular task to the construction machine assigned to the particular task for presenting the sequence of actions for performing the particular task.

11. The apparatus as recited in claim 10, the operations further comprising:
monitoring a performance of a user of the construction machine assigned to each particular task based on a performance metric defined for the particular task.

12. The apparatus as recited in claim 11, the operations further comprising:
sending feedback data to the construction machine assigned to each particular task based on the performance of the user.

13. The apparatus as recited in claim 10, wherein updating the parameters of each of the plurality of tasks based on respective operational models defining sequences of actions for performing the respective task comprises:
selecting the respective operational models based on a type of the respective task.

14. The apparatus as recited in claim 10, wherein modifying the one or more parameters of each particular task based on an operational model defining a sequence of actions for performing the particular task comprises:
selecting the operational model defining the sequence of actions for performing the particular task based on a type of the particular task.

15. The apparatus as recited in claim 10, wherein modifying the one or more parameters of each particular task based on an operational model defining a sequence of actions for performing the particular task comprises:
modifying the one or more parameters of each particular task based on the operational model defining a location of the construction machine assigned to the particular task for performing the particular task.

16. A computer readable medium storing computer program instructions for scheduling tasks of a construction project, which, when executed on a processor, cause the processor to perform operations comprising:
dividing a plan for a construction project into a plurality of tasks, each particular task of the plurality of tasks defined by one or more parameters;
modifying the one or more parameters of each particular task based on an operational model defining a sequence of actions for performing the particular task;
assigning a construction machine to each particular task based on the modified one or more parameters of the particular task; and
dispatching each particular task to the construction machine assigned to the particular task for presenting the sequence of actions for performing the particular task.

17. The computer readable medium as recited in claim 16, wherein modifying the one or more parameters of each particular task based on an operational model defining a sequence of actions for performing the particular task comprises:
synchronizing a timing and operational trajectories of a plurality of construction machines for performing the particular task.

18. The computer readable medium as recited in claim 16, wherein dividing a plan for a construction project into a plurality of tasks comprises:
dividing the plan for the construction project into the plurality of tasks having a granularity determined based on at least one of machine resource availability, geographic region constraints, and material type.

19. The computer readable medium as recited in claim 16, wherein the one or more parameters of each particular task comprise at least one of a geographic region, a target surface, a material type, and a material destination.

20. The computer readable medium as recited in claim 16, wherein the plan for the construction project includes at least one of a surface model for a geographic region of the construction project, a bill of materials for the construction project, and machine resource availability.
